(19) United States
(12) Patent Application Publication
(10) Pub. No.: US 2025/0012896 A1
(43) Pub. Date: Jan. 9, 2025

(54) OPTOELECTRONIC COMPONENT, LIDAR MODULE AND METHOD FOR OPERATING A LIDAR MODULE

(71) Applicant: ams-OSRAM International GmbH, Regensburg (DE)

(72) Inventors: Simon LANKES, Regensburg (DE); Hubert HALBRITTER, Dietfurt (DE); Reiner WINDISCH, Pettendorf (DE)

(73) Assignee: ams-OSRAM International GmbH, Regensburg (DE)

(21) Appl. No.: 18/712,335

(22) PCT Filed: Nov. 22, 2022
(86) PCT No.: PCT/EP2022/082806

§ 371 Date: May 22, 2024

(30) Foreign Application Priority Data
Nov. 24, 2021 (DE) 102021130773.2

(51) Int. Cl. G01S 7/481

(52) U.S. Cl. CPC G01S 7/4811; G01S 7/4815; G01S 7/4816

(57) ABSTRACT

An optoelectronic component for a LiDAR module includes a carrier, a laser light source, and a detector element. The laser light source is designed for the generation of coherent electromagnetic radiation of a wavelength L1. The detector element is designed for coherent detection of incoming electromagnetic radiation of the wavelength L1 depending on a local oscillator signal. The laser light source and the detector element are arranged opposite one another on different sides of the carrier such that, during operation, electromagnetic radiation generated from the laser light source is coupled into the detector element via a first main surface through the carrier as the local oscillator signal and is coupled out via a second main surface.

### CROSS-REFERENCE TO RELATED APPLICATIONS

The present application is a national stage entry from International Application No. PCT/EP2022/082806, filed on Nov. 22, 2022, published as International Publication No. WO 2023/094378 A1 on Jun. 1, 2023, and claims priority to German Patent Application No. 10 2021 130 773.2, filed Nov. 24, 2021, the disclosures of all of which are hereby incorporated by reference in their entireties.

### FIELD

The following description relates to an optoelectronic device for a LiDAR module, a LiDAR system and a method for operating a LiDAR module.

### BACKGROUND

Optical devices and optical sensors are used in a wide range of applications in the consumer and automotive sectors. Light Detection and Ranging (LiDAR for short), for example, is a key technology for mobile devices such as cell phones, computers and tablets, and is also increasingly being used in robots and vehicles such as autonomous vehicles. Today's LiDAR systems typically emit short pulses of light at a fixed frequency. The position of objects can be derived from a measurement that determines how long it takes for these laser pulses to be reflected or scattered by surfaces and return to the sensor. The further away an object is, the longer it takes for the light to return.

Modern LiDAR systems can also use a constant stream of light (“continuous wave”, cw) and change the frequency of this light at regular intervals (“frequency modulated”, fm). Such FMCW LiDAR systems (Frequency Modulated Continuous Wave LiDAR) can both determine the location of objects and measure their speed using the Doppler effect.

In a conventional configuration, FMCW LiDAR systems use a superposition of a local oscillator with a received signal in common direction. This requires a complex setup, either two optics for transmitter and receiver, or an optical circulator. Alternatively, the local oscillator (or local oscillator signal) and receive signal can be superimposed in reverse. This enables a simpler geometry and thus possibly the realization of FMCW arrays.

In general, the coherent superposition of local oscillator and received signal on a detector requires precise adjustment. In addition, the backscattered received signal must be mixed with the local oscillator with sufficient overlap of the wavefronts. At present, this can only be achieved using complex waveguide structures. This is associated with coupling losses and a circulator and isolator are required. Arrangements as an array (such as in flash LiDAR systems) often suffer from cross-talk between the pixels in FMCW.

It is an object of the present disclosure to propose an optoelectronic device for a LiDAR system and a LiDAR system that enables a more compact design.

These objects are achieved by the subject-matter of the independent claims. Further developments and embodiments are described in the dependent claims and are apparent from the following description and the drawings.

### SUMMARY

It is understood from the following that any feature described in relation to any embodiment may be used alone or in combination with other features described below, and may also be used in combination with one or more features of any other embodiment or any combination of any other embodiment, unless described as an alternative. Furthermore, equivalents and modifications not described below may also be used without departing from the scope of the proposed optoelectronic device, LiDAR system and method of operating a LiDAR module defined in the accompanying claims.

In the following, an improved concept in the field of optical devices for LiDAR systems is presented. The proposed concept is based on a laser light source and a detector element arranged on opposite sides of a carrier, for example a substrate. The laser light source can be a narrow-band single-mode VCSEL (vertical-cavity surface-emitting laser) or PCSEL (photonic crystal surface emitting laser). A local oscillator can be coupled into the detector element via a partially transparent mirror of the laser light source through the carrier. In this way, for example, a coherent superposition of opposing waves from the received signal and the local oscillator can be realized in the detector. Such a 1:1 relationship between laser light source and detector element enables measures to reduce optical crosstalk in an array arrangement.

According to at least one embodiment, an optoelectronic device, in particular for a LiDAR module, comprises a carrier, a laser light source and a detector element. The laser light source is configured to generate coherent electromagnetic radiation with a wavelength L1. Furthermore, the detector element is configured to coherently detect incoming electromagnetic radiation with the wavelength L1 as a function of a local oscillator signal.

The laser light source and the detector element are arranged on different sides of the carrier opposite each other in such a way that, during operation, electromagnetic radiation generated by the laser light source is coupled in through the carrier into the detector element via a first main surface of the laser light source and is coupled out via a second main surface. The light emitted via the first main surface serves as the local oscillator signal. The light emitted via the second main surface serves as the transmitted signal.

The electromagnetic radiation, or laser light, generated by the laser light source is produced by stimulated emission and, in contrast to electromagnetic radiation generated by spontaneous emission, usually has a very high coherence length, a very narrow spectral linewidth and/or a high degree of polarization. Preferably, the coherence length of the laser light source is greater than twice the maximum distance between the optoelectronic device, for example installed in a LiDAR module, and an external object that should still be detectable. The laser light source comprises, for example, a semiconductor laser, in particular a surface-emitting laser diode, an edge-emitting laser diode, a fiber laser, a fiber-reinforced laser, a laser with distributed feedback (DFB laser), or any variants thereof.

The laser light source and the detector element are arranged on opposite sides of the carrier, for example a substrate, with respect to a surface normal of the carrier or integrated into the carrier. For example, the laser light source and the detector element are arranged perpendicularly on the carrier with an axis parallel to the growth direction of a semiconductor layer sequence.

For example, one or more active regions of the detector element are aligned with the first main surface of the laser light source.

The carrier can, for example, comprise a growth substrate or be formed from a growth substrate on which the semiconductor layer sequence is grown epitaxially. Alternatively, the carrier is not a growth substrate. For example, the carrier comprises gallium arsenide, silicon, or sapphire or consists of gallium arsenide, silicon, or sapphire. In particular, the carrier is transparent to electromagnetic radiation of wavelength L1 that is at least partially absorbed by the at least two active layers, for example a semiconductor layer sequence. Here and in the following, transparent means that at least 80%, preferably at least 90%, of the electromagnetic radiation with the wavelength L1 incident on the carrier is transmitted through the carrier.

An optoelectronic device described herein can be used in a LiDAR module. In particular, the optoelectronic device is suitable for differential detection of FMCW LiDAR signals. A transmit signal, which in particular comprises frequency-modulated laser light with the wavelength L1 in the infrared spectral range, and a receive signal are coherently superimposed in the detector element. The received signal, or reflection signal, comprises the transmitted signal that is at least partially reflected by an external object. Coherently superimposed here and in the following means that the transmitted signal is coupled into the detector element via a first side, for example by means of the first main surface of the laser light source, while the received signal is coupled into the detector element via a second side after emission by means of the second main surface of the laser light source and reflection or scattering by an external object, or vice versa. With the optoelectronic element described here, the detector element and laser light source are aligned with each other on the carrier. In this way, beam guidance optics can be used for the transmitted signal and the received signal. In particular, the detector element is configured with opposing superposition of the transmitted signal and the received signal, so that the beam guidance optics can be used with a single optic each for the transmitter and the receiver.

According to at least one further embodiment, the detector element is configured to couple the incoming electromagnetic radiation as a received signal and the local oscillator signal into an active area in counter direction and to superimpose them coherently. The active region can comprise one or more active layers of a semiconductor layer sequence. An active region can comprise several semiconductor layers, including several quantum well structures.

By superimposing the transmitted signal and the received signal in counter direction, a standing electromagnetic wave with a wavelength L1/n is formed in the detector element, for example, where n denotes an average refractive index of the detector element, for example of a semiconductor material of a semiconductor layer sequence in the detector element. For example, when two linearly polarized, plane electromagnetic waves of the transmitted signal and the received signal are superimposed in counter direction with electric field strengths of the form E_{1,2}=E_{1,2} e^{i(k}^{_{1,2}}^{x-ω}^{_{1,2}}^{t)} where E_{1,2} denotes amplitudes, ω_{1,2} frequencies, x a direction of propagation and t a time, and for the wave numbers k_{1,2} of the opposing waves k₁=−k₂=k=2πn/L1 an intensity of an electric field in the detector element is given by

$${\vert {E}_{1} + {E}_{2} \vert}^{2} = {E}_{1}^{2} + {E}_{2}^{2} + 2 {E}_{1} {E}_{2} cos ( 2 kx - ( {ω}_{1} - {ω}_{2} ) t ) .$$

In particular, a phase of the standing wave is proportional to a differential frequency ω₁−ω₂.

In a distance measurement using FMCW-LiDAR, a frequency of the transmitted signal is ω₁ of the transmitted signal is increased or decreased linearly as a function of time. The superposition of the transmitted signal and the received signal in the detector element results in a beat, whereby the difference frequency ω₁-ω₂ between the frequency ω₁ of the transmitted signal and the frequency ω₂ of the received signal is proportional to a distance to the external object. The detector element is configured to detect the difference frequency ω₁-ω₂ between the transmitted signal and the received signal. Particularly advantageous is the differential detection, whereby an interfering, time-independent part E₁²+E₂² of the standing electromagnetic wave is eliminated.

LiDAR detectors with superposition of the transmitted signal and the received signal in common direction require in particular an optical circulator or separate optics for a transmitter and a receiver. An optical circulator is not necessary for the proposed optoelectronic device. This simplifies the design of a LiDAR module.

Furthermore, differential detection of the difference frequency improves the signal-to-noise ratio. In particular, interfering intensity fluctuations that can occur during frequency modulation of the transmitted signal are eliminated. In particular, differential detection with a single semiconductor device is possible with the optoelectronic element described here. This means that two separate photodetectors and a laser light source do not have to be arranged and adjusted.

According to at least one further embodiment, the detector element comprises a photodiode and/or a balanced photodiode.

For example, without differential detection a photodiode can be used, whereby the thickness of the absorbing layer should not correspond exactly to a multiple of half the light wavelength in the detector material, as in this case the signal would be independent of the phase position and would not vary over time. Alternatively, a pair of differential detectors can be used, which can be designed in such a way that one detector in the quasi-stationary wave is aligned as precisely as possible in phase opposition to the other detector.

According to at least one embodiment, the detector element has an epitaxial semiconductor layer sequence with at least two active layers.

According to at least one further embodiment, the at least two active layers are configured to absorb electromagnetic radiation with the wavelength L1. Preferably, the wavelength L1 of the electromagnetic radiation to be absorbed is in the infrared spectral range, for example between 800 nanometers and 1800 nanometers inclusive.

Differential detection can be carried out, for example, in a photodiode and in a balanced photodiode by determining the intensity of the electric field in the detector element. In particular, one detector element can be arranged at each of two different locations, for example at a distance of a quarter of the wavelength, i.e. L1/(4*n). In particular, photocurrents generated by the active layers are proportional to the intensity of the electric field. By subtracting the photocurrents of the two active layers at a distance L1/(4*n), whereby the distance can also be greater by multiples of half the wavelength L1/(2*n), the time-independent component of the standing electromagnetic wave is eliminated, while the component oscillating in time with the difference frequency is added. A measurement signal produced by subtracting the two photocurrents of the two active layers thus exhibits a temporal oscillation with the difference frequency (ω₁-ω₂.

According to at least one further embodiment, the epitaxial semiconductor layer sequence has a first main surface and a second main surface opposite the first main surface, which are each configured for the coupling in of electromagnetic radiation and for the decoupling out of electromagnetic radiation, in particular with the wavelength L1.

The first main surface or the second main surface of the balanced photodiode are opposite the first or the second main surface of the laser light source in such a way that electromagnetic radiation generated by the laser light source, in particular with the wavelength L1, can be coupled into the balanced photodiode.

Here and in the following, main surfaces of the epitaxial semiconductor layer sequence are arranged normal to the growth direction of the semiconductor layer sequence. In other words, main surfaces of the semiconductor layer sequence are oriented parallel to the main extension plane of semiconductor layers of the semiconductor layer sequence. The main surfaces delimit the semiconductor layer sequence. Epitaxial semiconductor layers are arranged in particular between the two main surfaces.

According to at least one further embodiment, the epitaxial semiconductor layer sequence is arranged on the carrier.

According to at least one further embodiment, the detector element comprises at least three electrical connection contacts which are configured for making electrical contact with the active layers, with one electrical connection contact being arranged between two active layers.

For example, the epitaxial semiconductor layer sequence comprises exactly two active layers and exactly three electrical connection contacts, one electrical connection contact being arranged on each of the two main surfaces of the epitaxial semiconductor layer sequence, while a third electrical connection contact is arranged between the two active layers. Thus, the two active layers can be electrically contacted independently of each other.

According to one embodiment, the detector element comprises:
an epitaxial semiconductor layer sequence having at least two active layers which are configured to absorb electromagnetic radiation having a wavelength L1, the epitaxial semiconductor layer sequence having a first main surface and a second main surface opposite the first main surface, which are each configured for coupling in and coupling out electromagnetic radiation, and
at least three electrical connection contacts which are configured to make electrical contact with the active layers, one electrical connection contact being arranged between two active layers.

According to a further embodiment of the detector element, each active layer comprises at least one p-doped semiconductor layer and at least one n-doped semiconductor layer, which form a photodiode. In particular, the photodiode is configured to convert electromagnetic radiation into an electrical photocurrent.

According to at least one further embodiment of the detector element, at least one active layer has a multiple quantum well structure.

Here and in the following, the term quantum well structure includes in particular any structure in which charge carriers can undergo quantization of their energy states through confinement. In particular, the term quantum well structure does not include any indication of the dimensionality of the quantization. It therefore includes quantum wells, quantum wires and quantum dots and any combination of these structures.

According to at least one further embodiment of the detector element, two active layers, between which an electrical connection contact is arranged, are implemented as photodiodes with opposite forward direction.

The two photodiodes with opposite forward direction of the detector element are, for example, part of a differential amplifier circuit that only measures the spatially oscillating component of the standing electromagnetic wave within the detector element. This allows, in particular, the interfering uniform component of the standing electromagnetic wave to be eliminated. This reduces, for example, the intensity of noise when the transmitted signal is superimposed on the received signal, which means that an improved signal-to-noise ratio can be achieved.

According to at least one further embodiment of the detector element, the two active layers, between which an electrical connection contact is arranged, are implemented as photodiodes with the same forward direction, with a tunnel diode being arranged between the active layers.

The two photodiodes with the forward pass direction of the detector element are, for example, part of an electrical circuit of a symmetrical photodetector. This allows small differences in the photocurrents of the two photodiodes to be measured accurately using a transimpedance amplifier. In particular, an output signal of a symmetrical photodetector is proportional to the difference in the photocurrents of the two photodiodes.

According to at least one embodiment, the laser light source comprises a surface-emitting semiconductor layer sequence.

For example, the surface-emitting semiconductor layer sequence comprises two dielectric mirrors between which an active layer for generating coherent electromagnetic radiation is arranged. The dielectric mirrors comprise, for example, a sequence of dielectric layers forming a Bragg mirror. The mirrors may, for example, be at least partially transparent to electromagnetic radiation generated during operation. The transmitted signal generated by the active layer can be coupled into the detector element via the first main surface of the laser light source and coupled out via the second main surface of the laser light source. At least one of the mirrors can be an external mirror.

According to at least one embodiment, the surface-emitting semiconductor layer sequence is implemented as a VCSEL (vertical-cavity surface-emitting laser) and/or as a PCSEL (photonic crystal surface-emitting laser). These designs are particularly suitable for arrangement on the carrier because their semiconductor layer sequences allow suitable beam directions towards the carrier or the detector element.

According to at least one embodiment, the optoelectronic device comprises a plurality of laser light sources and detector elements arranged on the carrier in pairs facing each other on the carrier. For example, the pairs are arranged along the carrier, i.e. opposite each other in pairs. Furthermore, the pairs may be electrically connected to each other and/or to further devices of the optoelectronic device through the carrier. For example, further devices can be arranged on the carrier or integrated into it. Such devices are, for example, driver circuits that operate the laser light sources, for example to enable frequency-modulated generation of electromagnetic radiation. Other devices include microcontrollers and analog or digital circuits.

All features disclosed for the detector element and the laser light source are also disclosed for the pairs of the plurality of laser light sources and detector elements, and vice versa.

Due to the large number of laser light sources and detector elements on the carrier, these can be provided with a common beam guidance optic in a LiDAR module and thus arranged in a particularly compact way. The paired relationship of laser light sources and detector elements enables an array arrangement and measures to reduce crosstalk.

According to at least one further embodiment, laser light sources and detector elements of the plurality of laser light sources and detector elements are each arranged in pairs for generating and detecting electromagnetic radiation having one wavelength. At least one other pair is arranged for generating and detecting electromagnetic radiation with a different wavelength. In other words, pairs can be detuned in wavelength with respect to other pairs. Radiation of other wavelengths can be detected non-coherently so that optical crosstalk can be further reduced.

A LiDAR module is further disclosed. All features disclosed for the detector element are also disclosed for the LiDAR module, and vice versa.

According to at least one embodiment, a LiDAR module comprises at least one optoelectronic element according to one or more of the aspects discussed above. A beam guiding optic is arranged to guide a transmitted signal to an external object and to guide a received signal to a detector element.

According to at least one embodiment, the LiDAR module has a plurality of detector elements and light sources arranged on the carrier, in particular a transparent carrier, which form a one-dimensional or two-dimensional detector array.

By arranging a large number of detector elements in a one- or two-dimensional detector array, a direction of the received signal in particular can be determined in conjunction with the beam guiding optics. A LiDAR module with a detector array as described here is therefore suitable for determining the distance and direction of an external object at the same time. Furthermore, a radial velocity of the external object can be determined via a Doppler shift of the difference frequency between the transmitted signal and the received signal.

According to at least one embodiment, at least one laser light source has an outcoupling wedge. In addition, or alternatively, at least one detector element has an coupling-in wedge. The wedges can be used to incline one or more of the main surfaces of the laser light source and/or the detector element, for example with respect to an axis parallel to the growth direction of the semiconductor layers.

The wedges have optical properties and can direct the transmitted signal and/or received signal by refraction. In this sense, the wedges can support the beam guiding optics. For example, the beam guiding optics can be made smaller and the LiDAR module thus more compact.

According to at least one embodiment, the beam guiding optics comprises a mirror, a prism and/or a lens.

Furthermore, a method for operating a LiDAR module is disclosed. All features of the LiDAR module are also disclosed for the method for operating a LiDAR module and vice versa.

According to at least one embodiment, the method for operating a LiDAR module comprises emitting a transmitted signal, wherein the transmitted signal comprises a frequency-modulated electromagnetic wave generated by the laser light source, which on the one hand passes through the carrier and is coupled into the detector element as a local oscillator. On the other hand, the transmitted signal is outcoupled from the laser light source and transmitted to an external object. where it is then at least partially reflected by the external object. The reflected transmitted signal can be redirected as a received signal by the LiDAR module and coupled into the detector element. In the detector element, the received signal can be detected coherently as incoming electromagnetic radiation as a function of the local oscillator signal.

In particular, the LiDAR module corresponds to at least one of the embodiments described herein.

The transmitted signal generated by the laser light source is thus preferably coupled into the detector element of the LiDAR module via the first main surface and outcoupled via the second main surface of the laser light source. Part of the transmitted signal passes through the detector element as a local oscillator.

According to at least one further embodiment of the method for operating a LiDAR module, a received signal is received which comprises the transmitted signal at least partially reflected by an external object. The received signal is coupled into the detector element via the second main surface and superimposed there with the counter-propagating transmitted signal as a local oscillator, forming a standing electromagnetic wave.

According to another embodiment of the method for operating a LiDAR module, a differential measurement of a beat frequency of the standing wave is performed by measuring the photocurrents of the active layers with a differential amplifier.

A differential amplifier is particularly suitable for differential measurement of the photocurrents of a detector element in which the active layers form two photodiodes with opposite forward directions. With a differential amplifier, the amplification of the photocurrents of the two photodiodes can be set separately. This allows, in particular, a systematic difference in intensity of the electromagnetic field in the two photodiodes to be compensated.

Alternatively, a transimpedance amplifier can be used for symmetrical photodetection with a detector element in which the active layers form two photodiodes with the same forward direction.

According to at least one further embodiment of the method for operating a LiDAR module, a distance to the external object is determined from the measured beat frequency.

In continuous wave LiDAR systems, for example, a frequency of the transmitted signal is periodically increased and/or decreased linearly as a function of time. The difference frequency between the transmitted signal and the received signal at the time of detection of the received signal is thus proportional to a time of flight of the transmitted signal between the transmission and the reception of the transmitted signal at least partially reflected by an external object. The distance to the external object can be determined from the time of flight. The difference frequency can, for example, be determined using a fast Fourier transformation of the output signal of the differential amplifier. Furthermore, a Doppler shift of the frequency of the received signal can be used to determine a radial velocity of the external object.

According to at least one further embodiment of the method for operating a LiDAR module, a systematic difference in intensity of the electromagnetic radiations in the active layers is compensated by a dynamic circuit.

Both the transmitted signal and the received signal are at least partially absorbed as they pass through the detector element. The overall intensity of the electromagnetic field within the detector element is dominated in particular by the stronger transmitted signal. This means that the overall intensity of the electromagnetic field in the detector element decreases in the direction in which the transmitted signal passes through. If the active layers in the detector element have the same thickness, this results in a systematic difference in the photocurrents generated by the active layers. This systematic difference can be compensated for in particular by a dynamic circuit. For example, the amplification of the individual photocurrents can be set separately in a differential amplifier circuit.

Further advantages and advantageous embodiments as well as further embodiments of the description presented result from the embodiments described below in conjunction with figures.

In the exemplary embodiments and figures, components that are identical or have the same effect may each be provided with the same reference symbols. The elements shown and their proportions to one another are not to be regarded as true to scale; rather, individual elements, such as layers, components, structural elements and areas, may be shown in exaggerated thickness or large dimensions for better visualization and/or better understanding.

### BRIEF DESCRIPTION OF THE DRAWINGS

FIGS. 1 to 5 show exemplary embodiments of LiDAR modules with optoelectronic devices according to the present disclosure.

### DETAILED DESCRIPTION

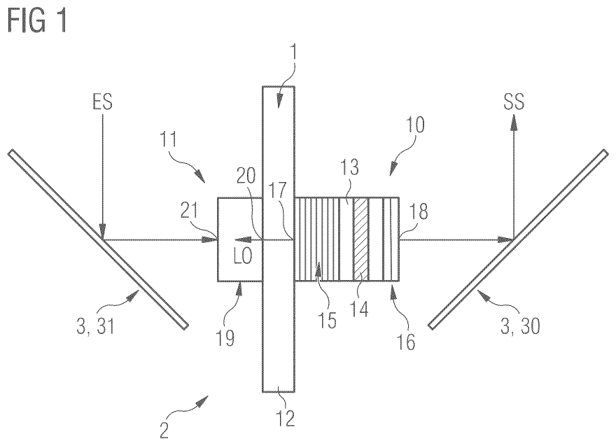

FIG. 1 shows an exemplary embodiment of a LiDAR module with an optoelectronic device. The LiDAR module 2 comprises an optoelectronic device 1 and beam guiding optics 3.

The optoelectronic device 1 further comprises a laser light source 10 and a detector element 11. The laser light source and the detector element are arranged on a common carrier 12 opposite each other and on opposite sides of the carrier or integrated therein. The carrier 12 is, in particular, a growth substrate consisting of InP or GaAs, for example. In this example, the laser light source comprises a surface-emitting laser diode, such as a VCSEL or a PCSEL. The detector element can, for example, be implemented as a photodiode or as a balanced photodiode.

The laser light source 10 comprises a surface-emitting semiconductor layer sequence 13. The surface-emitting semiconductor layer sequence comprises an active layer 14 for generating electromagnetic radiation of wavelength L1, for example of 1550 nanometers or 900 nanometers. This active layer 14 is arranged between two dielectric mirrors 15, 16, which form an optical resonator. The dielectric mirrors 15 comprise a plurality of dielectric layers with alternating refractive indices, which form a Bragg reflector. Here, a first dielectric mirror 15 is arranged on the carrier 12 and is at least partially transparent to electromagnetic radiation generated during operation. The first dielectric mirror 15 comprises a first main surface 17 of the laser light source. The second dielectric mirror 16 is not arranged on the carrier 12 but spaced therefrom. The second dielectric mirror 16 is at least partially transparent to electromagnetic radiation generated during operation. The second dielectric mirror 16 comprises a second main surface 18 of the laser light source.

Alternatively, the second dielectric mirror 16 can be designed as an external mirror that is not integrated into the surface-emitting semiconductor layer sequence. The external mirror can be used, for example, to reduce the spectral linewidth of the laser light source and/or to increase the coherence length of the laser light source.

The detector element 11 comprises an epitaxial semiconductor layer sequence 19, which is epitaxially grown on the carrier 12. The epitaxial semiconductor layer sequence 19 is opposite the surface-emitting semiconductor layer sequence 13. The detector element 11 and the laser light source 10 can form a monolithic semiconductor layer stack with the carrier and the semiconductor layer sequences 13, 19. Alternatively, the detector element 11 and/or the laser light source 10 can be mounted on the carrier.

The detector element 11 comprises a first and a second main surface 20, 21. The detector element 11 is arranged with the first main surface 20 on the carrier 12. The second main surface 21 is not arranged on the carrier 12 but spaced therefrom. The first main surfaces 17, 20 are directly opposite each other with respect to the carrier 12.

The beam guiding optics 3 comprises a coupling-out optics 30 and a coupling-in optics 31. The beam guiding optics is, for example, built into a housing or a part of a housing, such as a housing wall. The beam guiding optics comprises, for example, mirrors, lenses and/or prisms or a combination of these elements in order to optically direct electromagnetic radiation, for example a transmitted signal SS and a received signal ES. The coupling-out optics 30 couples out the transmitted signal by directing the transmitted signal towards an external object. The coupling-in optics 31 couples in the received signal by directing the received signal towards the detector element.

In this example, the beam guiding optics 3 or the coupling-out optics 30 and a coupling-in optics 31 are implemented as mirrors, each forming an angle of essentially 45 degrees with respect to the carrier 12. In this way, the transmitted signal is essentially coupled out at an angle of 90 degrees relative to the laser light source 10 (for example, defined by an axis that runs parallel to the growth direction of the semiconductor layer sequence of the laser light source). Furthermore, the received signal can be coupled in at an angle of 90 degrees with respect to the detector element 11 (for example, defined by an axis parallel to the growth direction of the semiconductor layer sequence of the detector element). Other angles can also be implemented.

During operation of the LiDAR module, the laser light source generates the transmitted signal SS, which in particular comprises frequency-modulated laser light with the wavelength L1 in the infrared spectral range. The transmitted signal is generated by the active layer 14 and frequency modulated, for example by a driver circuit. The transmitted signal generated in this way is outcoupled via two paths.

Firstly, the transmitted signal is initially coupled into the carrier 12 by the first dielectric mirror 15 or the first main surface 17 of the laser light source. The transmitted signal passes through the carrier and is thus coupled into the detector element 11 through the first main surface of the detector element 11. The transmitted signal is available there as a local oscillator LO.

On the other hand, the transmitted signal SS is outcoupled from the laser light source 10 by the second dielectric mirror 16 or the second main surface 18. The coupling-out optics 30 directs the transmitted signal in the direction of an external object (not shown). The transmitted signal is then reflected or scattered by the external object and can return to the LiDAR module 2 as a reflected signal. There, the coupling-in optics 31 collects the reflected signal and directs it as a received signal ES in the direction of the detector element 10, where the received signal is coupled in via the second main surface 21 of the detector element. In the detector element or the epitaxial semiconductor layer sequence 19, the received signal is superimposed on the transmitted signal as a local oscillator LO in counter direction. Detection takes place, for example, differentially with a beat frequency, which is a measure of the distance between the LiDAR module and the external object.

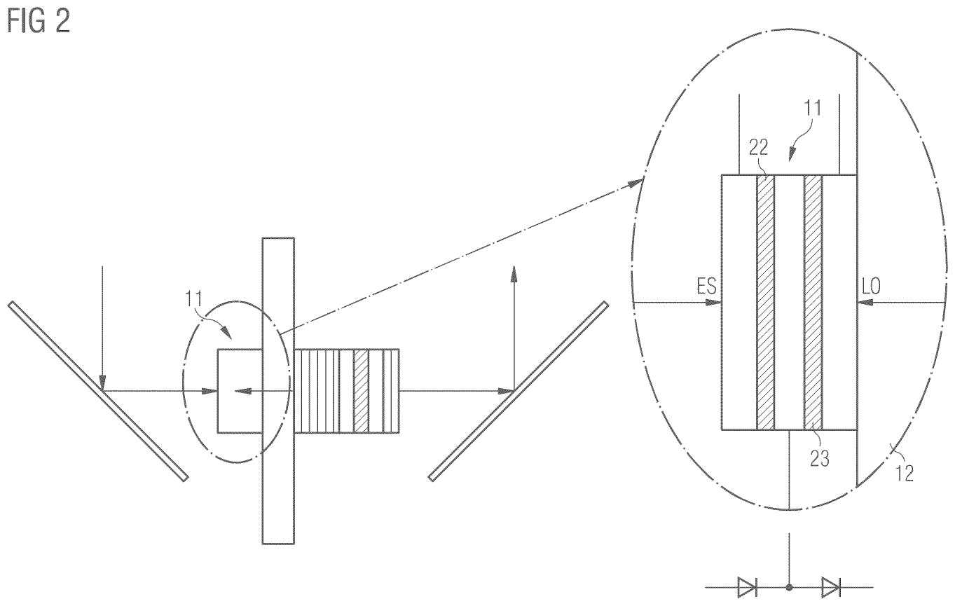

FIG. 2 shows another exemplary embodiment of a LiDAR module with an optoelectronic device. This example essentially corresponds to the structure shown in FIG. 1. Two alternative implementations of the detector element are indicated. On the one hand, a regular photodiode can be used, which allows a high DC component. For example, the epitaxial semiconductor layer sequence 19 is implemented as a photodiode.

As an alternative, a balanced photodiode is shown (see detail on the right), which comprises a semiconductor layer sequence with two active layers 22, 23, which have an average distance A1 and are configured to absorb electromagnetic radiation of a wavelength L1. The mean distance A1 is L1/(4*n), where n is the mean refractive index of the semiconductor layer sequence for electromagnetic radiation of wavelength L1. In other words, the mean distance A1 is a quarter of the wavelength of the electromagnetic radiation to be absorbed in the medium of the detector element. Alternatively, the distance A1 can also be greater by integer multiples of half the wavelength in the medium L1/(2*n), for example 3/4, 5/4, 7/4 of the wavelength of the electromagnetic radiation to be absorbed in the medium of the detector element.

The semiconductor layer sequence is structured such that a region between the two active layers 22, 23 is also electrically contacted. In particular, the detector element has three electrical connection contacts, with one connection contact being arranged between the two active layers (not shown).

Electromagnetic radiation of the transmitted signal SS is coupled in via the first main surface 17 through the carrier 12 into the epitaxial semiconductor layer sequence 19 as a local oscillator LO. The received signal ES, which comprises the transmitted signal SS at least partially reflected by an external object, is coupled into the detector element 11 via the second main surface 21 of the epitaxial semiconductor layer sequence 19.

The superposition in counter direction of the transmitted signal SS (as a local oscillator) and the received signal ES in the detector element forms a standing electromagnetic wave whose beat frequency corresponds to the difference frequency between the transmitted signal and the received signal. By selecting the distance A1 as described above, the first active layer 22 is located at a given point in time, for example at a node, i.e. at a point of vanishing intensity of the standing electromagnetic wave, while the second active layer 23 is located at a bulb, i.e. at a point of maximum intensity of the standing electromagnetic wave. A differential measurement, in which the photocurrents of the two active layers 22, 23 are subtracted, can thus eliminate an interfering, time-independent component of the standing electromagnetic wave.

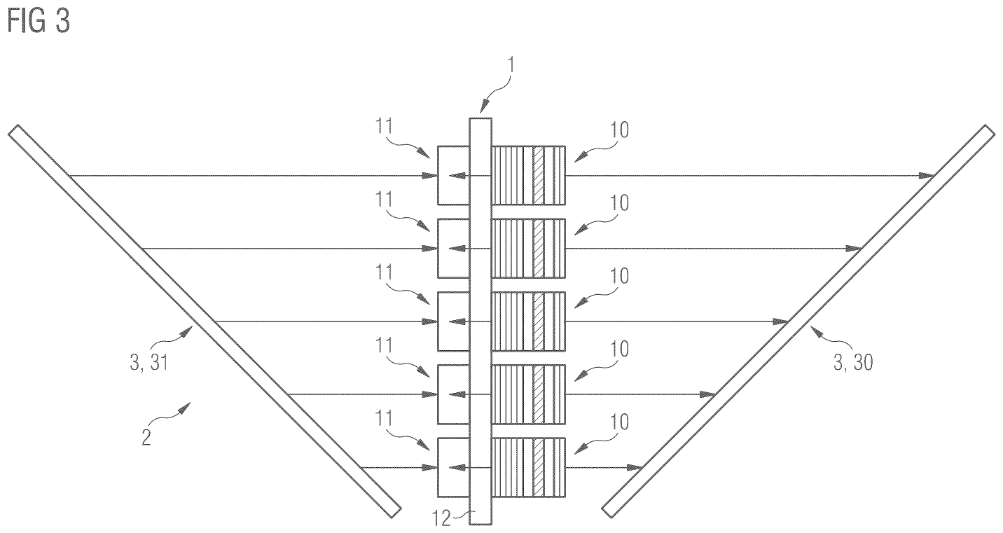

FIG. 3 shows a further exemplary embodiment of a LiDAR module with an optoelectronic device. A plurality of laser light sources 10 and detector elements 11 according to the embodiments of FIGS. 1 and/or 2 may also be arranged as a one-dimensional array or as a two-dimensional array. For example, the pairs are arranged along the carrier 12, i.e. opposite each other in pairs. For a two-dimensional array, the pairs may also be arranged perpendicular to the one-dimensional arrangement shown.

Furthermore, the pairs can be electrically connected to each other and/or to further components of the optoelectronic device through the carrier. For example, further components may be arranged on or integrated into the carrier 12. Such devices are, for example, driver circuits that operate the laser light sources, for example to enable frequency-modulated generation of electromagnetic radiation. Other components include microcontrollers and analog or digital circuits.

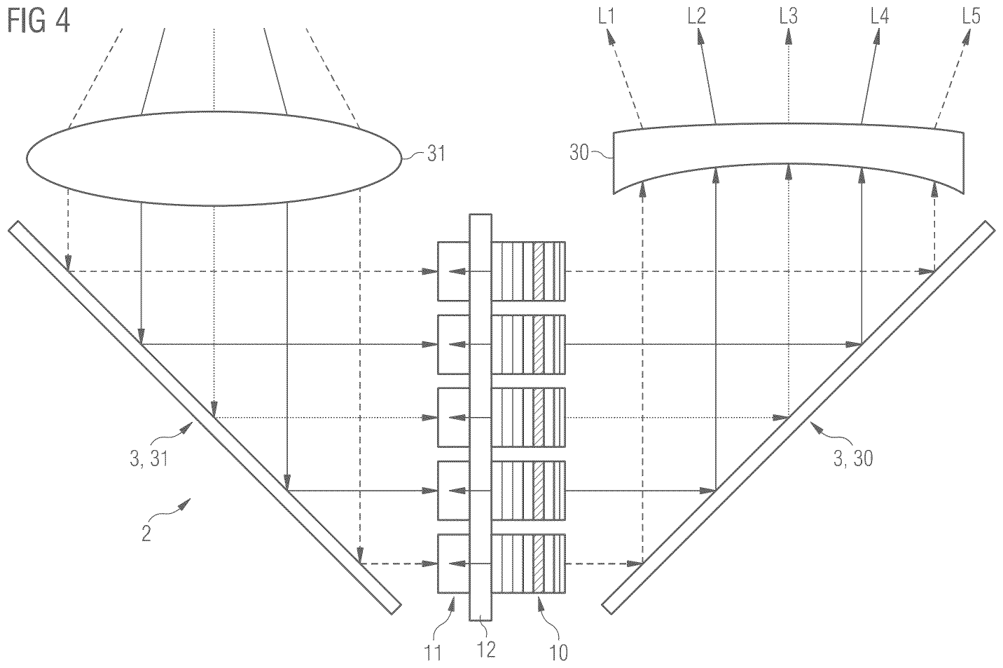

FIG. 4 shows another exemplary embodiment of a LiDAR module with an optoelectronic device. The possibility of arranging and operating a large number of laser light sources and detector elements to form arrays can be supplemented by a targeted detuning of the wavelengths of the generated transmission signals. As an example, five pairs of laser light sources and detector elements are shown arranged along the carrier. Each laser light source 10 is configured to generate electromagnetic radiation with a wavelength L1, . . . , L5, each of which is detuned, i.e. different from the wavelengths of the other laser light sources. This concept can be extended to any number of laser light sources.

In this way, detuned transmitted signals with the wavelengths L1, . . . , L5 are generated and outcoupled by the coupling-out optics 30. The coupling-out optics also include a scattering lens to direct the transmission signals evenly onto the external object. The coupling-in optics 31 is supplemented by a converging lens to collect the reflected transmitted signals SS and provide them to the detector element 11.

The laser light sources 10 and detector elements 11 are configured for the generation or detection of electromagnetic radiation of wavelengths L1, . . . , L5, for example, by means of their respective semiconductor layer sequences.

This detuning of the laser light sources has the effect that the transmitted signals or the received signals are not coherent with each other. Coherent detection is therefore only possible for transmitted signals and received signals that are connected to a common pair of laser light source and detector element. This reduces optical crosstalk.

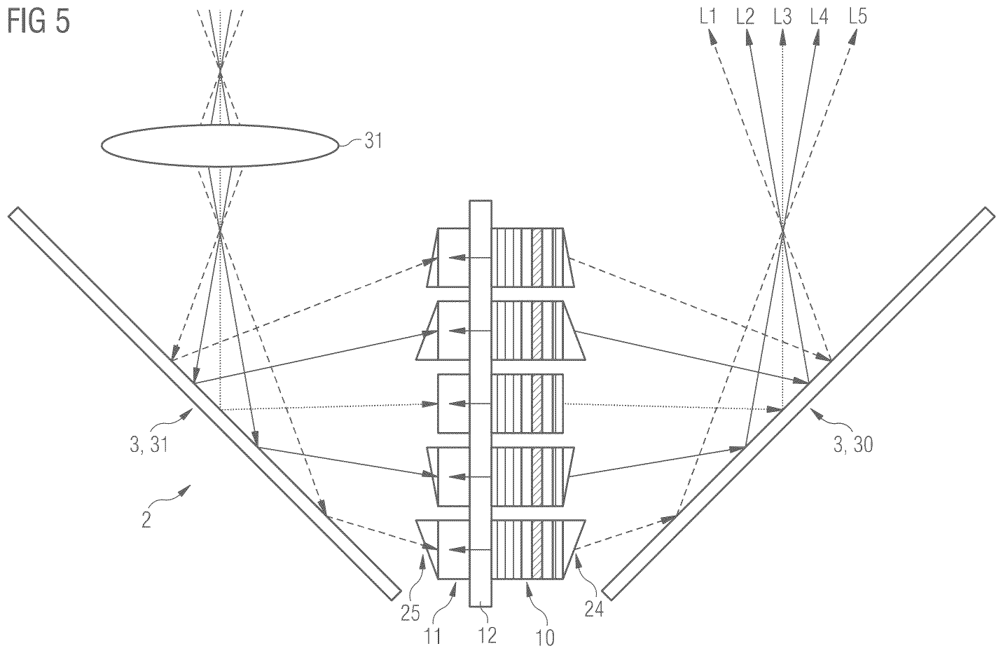

FIG. 5 shows another exemplary embodiment of a LiDAR module with an optoelectronic device. This example is an alternative to the embodiment example of FIG. 4. Here, some or all of the laser light sources and detector elements have a coupling-out or coupling-in wedge 24, 25. The coupling-out or coupling-in wedges have the effect of modifying the main surfaces of the laser light sources and detector elements or the semiconductor layers of the laser light sources and/or detector elements. In this way, electromagnetic radiation can be emitted or detected in a direction that has a propagation direction with an angle set by the wedge. The angle is defined, for example, by an axis parallel to the direction of growth.

Coupling-out or coupling-in wedges allow greater freedom in the optical design of the beam guiding optics. For example, the coupling-out wedges 24 can be set so that the transmitted signals SS of the different wavelengths L1, . . . , L5 meet at a focal point. This means that there is no need for an additional spreading lens as in the example in FIG. 4. The coupling-in wedges can, for example, be set so that they complement coupling-in optics 31. For example, the coupling-in optics 31 can be kept smaller and only a small area can be illuminated with the received signal of the different wavelengths L1, . . . , L5.

The foregoing description explains many features in specific detail. These are not intended to be construed as limitations on the scope of the improved concept or what can be claimed, but rather as exemplary descriptions of features that are specific only to certain embodiments of the improved concept. Certain features described in this description in connection with individual embodiments may also be realized in combination in a single embodiment. Conversely, various features described in connection with a single embodiment may also be implemented in multiple embodiments separately or in any suitable sub-combination. Moreover, although features are described above as acting together in certain combinations and even originally claimed as such, one or more features from a claimed combination may in some cases be excluded from the combination, and the claimed combination may be directed to a sub-combination or variation of a sub-combination.

Although the drawings show operations in a particular order, this is not to be taken to mean that these operations must be carried out in the order shown or in sequential order, or that all the operations shown must be carried out to achieve the desired results. In certain circumstances, different sequences or parallel processing may be advantageous.

A number of implementations have been described. Nevertheless, various modifications can be made without departing from the spirit and scope of the improved concept. Accordingly, other implementations also fall within the scope of the claims.

1. An optoelectronic device for a LiDAR module, comprising a carrier, a laser light source and a detector element, wherein:
the laser light source is configured to generate coherent electromagnetic radiation with a wavelength L1,
the detector element is configured for coherent detection of incoming electromagnetic radiation with the wavelength L1 as a function of a local oscillator signal,
the laser light source and the detector element are arranged opposite one another on different sides of the carrier in such a way that electromagnetic radiation generated by the laser light source during operation is coupled into the detector element via a first main surface through the carrier as the local oscillator signal and is coupled out via a second main surface.

2. The optoelectronic device according to claim 1, wherein the detector element is configured to couple the incoming electromagnetic radiation as a received signal and the local oscillator signal into an active region in counter direction and to superimpose them coherently.

3. The optoelectronic device according to claim 1, wherein the detector element comprises a photodiode and/or a balanced photodiode.

4. The optoelectronic device according to claim 3, wherein the balanced photodiode comprises:
an epitaxial semiconductor layer sequence having at least two active layers which are configured to absorb electromagnetic radiation having the wavelength L1, the epitaxial semiconductor layer sequence having a first main surface and a second main surface opposite the first main surface, which are respectively configured for coupling in and for coupling out electromagnetic radiation, and
at least three electrical connection contacts which are arranged for making electrical contact with the active layers, one electrical connection contact being arranged between two active layers.

5. The optoelectronic device according to claim 4 in which each active layer comprises at least one p-doped semiconductor layer and at least one n-doped semiconductor layer forming a photodiode and/or in which at least one active layer comprises a multiple quantum well structure.

6. The optoelectronic device according to claim 1, wherein the laser light source comprises a surface-emitting semiconductor layer sequence.

7. The optoelectronic device according to claim 1, wherein the surface-emitting semiconductor layer sequence is implemented as a vertical-cavity surface-emitting laser, VCSEL, and/or as a photonic crystal surface-emitting laser, PCSEL.

8. The optoelectronic device according to claim 1, wherein a plurality of laser light sources and detector elements are arranged on the carrier in pairs facing each other.

9. The optoelectronic device according to claim 8, wherein laser light sources and detector elements of the plurality of laser light sources and detector elements are each arranged in pairs for generating and detecting electromagnetic radiation having a wavelength L1, . . . , L5, while at least one other pair is arranged for generating and detecting electromagnetic radiation having a different wavelength.

10. A LiDAR module, comprising:
an optoelectronic element according to claim 1, and
a beam guiding optics arranged for directing a transmitted signal to an external object and for directing a received signal to a detector element.

11. The LiDAR module according to claim 1, wherein
at least one laser light source comprises a coupling-out wedge, and/or
at least one detector element comprises a coupling-in wedge.

12. The LiDAR module according to claim 10, wherein the beam guiding optics comprises a mirror, a prism and/or a lens.

13. The LiDAR module according to claim 10, wherein a plurality of laser light sources and detector elements are arranged on the carrier as a one-dimensional or two-dimensional array.

14. A method of operating the LiDAR module according to claim 10, comprising:
transmitting a transmitted signal, wherein the transmitted signal comprises a frequency-modulated electromagnetic wave generated by the laser light source, which on the one hand passes through the carrier and is coupled as a local oscillator into the detector element and on the other hand is coupled out of the laser light source and is directed onto an external object, and is then at least partially reflected by the external object,
receiving a received signal which comprises the transmitted signal at least partially reflected by an external object, the received signal being directed into the detector element and coupled in there and superimposed in the detector element with the counter directed transmitted signal as a local oscillator, whereby a standing electromagnetic wave is formed,
differential measuring of a beat frequency of the standing electromagnetic wave by measuring photocurrents with a differential amplifier, and
determining of a distance to the external object from the beat frequency.
